(19) United States
(12) Patent Application Publication
(10) Pub. No.: US 2022/0048269 A1
(43) Pub. Date: Feb. 17, 2022

(54) SLOTTER APPARATUS, AND MACHINE FOR MANUFACTURE OF CARTON

(71) Applicant: MITSUBISHI HEAVY INDUSTRIES MACHINERY SYSTEMS, LTD., Hyogo (JP)

(72) Inventors: Kazuya AKITA, Hyogo (JP); Makoto SHIMOHATSUBO, Hyogo (JP)

(21) Appl. No.: 17/275,212

(22) PCT Filed: Jul. 26, 2019
(86) PCT No.: PCT/JP2019/029388

§ 371 Date: Mar. 11, 2021

(30) Foreign Application Priority Data
Sep. 14, 2018 (JP) 2018-172310

(51) Int. Cl. B31B 50/20; B31B 50/26; B31B 50/88

(52) U.S. Cl. CPC B31B 50/20; B31B 50/88; B31B 50/26

(57) ABSTRACT

A slotter apparatus includes a slotter knife rotatable in a same direction as a conveyance direction of a sheet that is conveyed on a conveyance path, the slotter knife having a cutting edge, for forming a notch groove in the sheet, on an outer periphery of the slotter knife. A protruding part protrudes outward from the cutting edge at one end of the slotter knife, the protruding part cutting an end part of the notch groove by piercing the sheet. A drive device that drives the slotter knife so as to rotate. A control device that, at least when the protruding part passes through from the upper surface of the sheet, controls the relative relationship between the circumferential velocity of the slotter knife and the conveyance velocity of the sheet so that the protruding part does not interfere with the end part.

### TECHNICAL FIELD

The present invention relates to a slotter device for forming a notch groove in a corrugated board in a corrugated box making machine and a box making machine.

### BACKGROUND ART

In a general box making machine, a sheet feeding section sends corrugated boards (hereinafter referred to as “sheets”) one by one to a printing section, the printing section performs predetermined printing on the sheets, and then a slotter creaser section and a die-cut section perform creasing, groove cutting, gluing margin processing, and hole forming in the sheets to process the sheets into sheets for manufacturing a box. Then, the folding section applies glue to a gluing margin while moving the sheet, folds the sheet along a creasing line, and joins the gluing margin. Accordingly, a corrugated box in a folded state is completed and sent to a counter-ejector section. The counter-ejector section stacks corrugated boxes in a folded state, sorts into a predetermined number of batches, and discharges the batches.

The slotter creaser section of such a box making machine includes a slotter device for performing groove cutting in a sheet.

As illustrated in FIG. 8, a slotter device 30 of the related art includes upper and lower slotter heads 31 and 32 which are disposed up and down to face each other with a transfer passage of a sheet 10 interposed therebetween, and two slotter knives 35 and 36 attached to the upper slotter head 31 are configured to form notch grooves 11 and 12 at the front and rear of the sheet 10 in a transfer direction as illustrated in FIG. 9.

The slotter knives 35 and 36 include, on one end portions thereof, protrusion portions 37 and 38 protruding outward from knife tips respectively, and end portions 13 and 14 of the notch grooves 11 and 12 are cut as the protrusion portions 37 and 38 pierce the sheet 10. The reason why the protrusion portions 37 and 38 are included is that the end portions 13 and 14 of the notch grooves 11 and 12 cannot be sheared or pushed off by the knife tips of the slotter knives 35 and 36.

However, the slotter device of the related art is known to perform rotation control of the upper slotter head 31 such that the rotation speeds and phases of the slotter knives 35 and 36 and the transfer speed and phase of the sheet match each other, in order to form the notch grooves 11 and 12 at appropriate positions on the sheet (for example, refer to PTL 1). Herein, the phases of the slotter knives correspond to the rotation angles of the knives, and the phase of the sheet corresponds to the position of the sheet in the transfer direction.

However, in a case where the circumferential speeds of the slotter knives 35 and 36 and the transfer speed of the sheet match each other, the diameters of the protrusion portions 37 and 38 are larger than the diameters of the slotter knives 35 and 36. Therefore, the circumferential speeds of the protrusion portions 37 and 38 are higher than the circumferential speeds of the slotter knives. Due to this speed difference, when forming the notch groove 12 at the rear, the protrusion portion 38 pierces the sheet and pushes into the end portion 14 of the notch groove 12, and then when the protrusion portion 38 comes out of the sheet, the protrusion portion gets caught in the end portion 14 of the notch groove 12. Accordingly, cracks (gouges) are generated in the end portion 14 of the notch groove 12 in some cases.

In order to solve the problem of cracks in the end portion, PTL 2 discloses a technique of providing a cutter in a creaser device provided upstream of a slotter device without providing a protrusion portion on a slotter knife for a notch end at the rear.

### CITATION LIST

### Patent Literature

[PTL 1] Japanese Unexamined Patent Application Publication No. 2004-237711

[PTL 2] Japanese Unexamined Patent Application Publication No. H9-39118

### SUMMARY OF INVENTION

### Technical Problem

However, in PTL 2, it is necessary to add a mechanism for preventing cracks in a notch groove, which complicates the structure.

In addition, in PTL 1, as for the rotation control of the slotter knife, while there is description on a speed difference between the circumferential speed of the outer circumference of the knife and the circumferential speed of the protrusion portion, there is not any description on recognition of a subsequent problem that cracks are generated in the end portion of the notch groove and a solution thereto.

The present invention is devised in view of such problems, and an object thereof is to provide a slotter device and a box making machine, which can prevent cracks in the end portion of the notch groove at the rear with a simple configuration.

### Solution to Problem

According to an aspect of the present invention, there is provided a slotter device including a slotter knife that is provided to rotate in the same direction as a transfer direction of a sheet being transferred through a transfer passage and includes, on an outer circumference thereof, a knife tip for forming a notch groove in the sheet, a protrusion portion that is provided to protrude outward from the knife tip on one end portion of the slotter knife and cuts an end portion of the notch groove by piercing the sheet, a drive device that rotationally drives the slotter knife, and a control device that controls a relative relationship between a circumferential speed of the slotter knife and a transfer speed of the sheet such that the protrusion portion does not interfere with the end portion of the notch groove at least when the protrusion portion comes out of an upper surface of the sheet.

### Advantageous Effects of Invention

In the present invention, it can be suppressed that cracks are generated in the end portion of the notch groove at the rear with a simple configuration of simply controlling a relative relationship between the circumferential speed of the slotter knife and the transfer speed of the sheet such that the protrusion portion does not interfere with the end portion of the notch groove at least when the protrusion portion comes out of the upper surface of the sheet.

### BRIEF DESCRIPTION OF DRAWINGS

FIG. 1 is a side view illustrating main parts of a slotter device according to an embodiment.

FIG. 2 is a view illustrating an overall configuration of a corrugated box making machine including the slotter device according to the embodiment.

FIG. 3 is a plan view illustrating the main parts of the slotter device and a sheet.

FIG. 4 is a schematic view illustrating a relationship between a protrusion portion of a slotter knife and the sheet when cutting a notch groove.

FIG. 5 is a time chart showing an example of speed increase and decrease control according to a sheet length.

FIG. 6 is a time chart showing another example of the speed increase and decrease control according to a sheet length.

FIG. 7 is a time chart showing still another example of the speed increase and decrease control according to a sheet length.

FIG. 8 is a side view for describing a slotter device of the related art.

FIG. 9 is a plan view for describing a sheet.

### DESCRIPTION OF EMBODIMENTS

Hereinafter, an embodiment of the present invention will be described with reference to the drawings.

Each embodiment described below is merely an example, and is not intended to exclude application of various modifications and techniques that are not specified in the embodiment below. Respective configurations of the embodiment below can be variously modified and implemented without departing from the spirit thereof, can be selected and discarded if necessary, or can be combined with each other as appropriate.

[Overall Configuration of Box Making Machine]

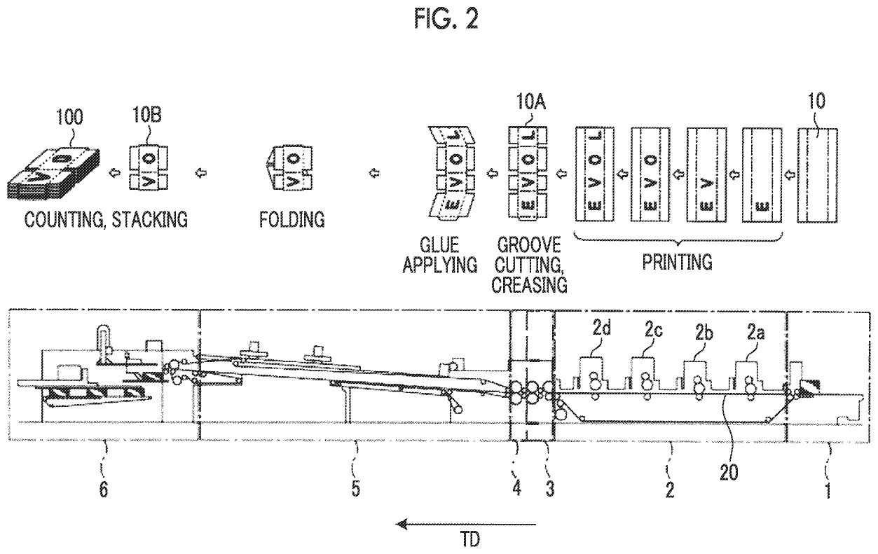

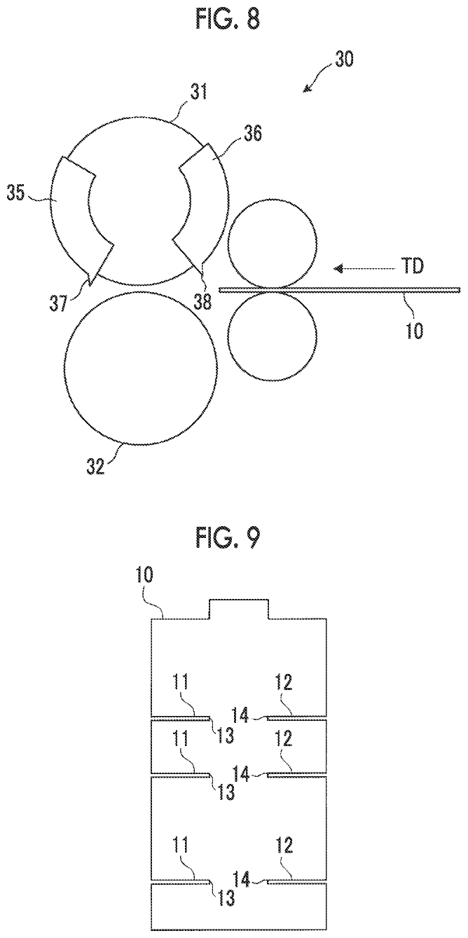

A slotter device according to the present embodiment is a slotter device mounted on a box making machine. First, the box making machine including the slotter device according to the present embodiment will be described with reference to FIG. 2. In the following description, a sheet transfer direction TD will be referred to as front, an opposite direction thereto will be referred to as rear, a gravity direction (vertically downward direction) will be referred to as down, and an opposite direction (vertically upward direction) thereto will be referred to as up. In addition, a machine width direction of the box making machine (a direction perpendicular to the transfer direction TD and a vertical direction) will be referred to as a right-and-left direction. In addition, components of the slotter device and the sheet, which are described with reference to FIGS. 8 and 9, will be assigned with reference signs common to corresponding elements also in the following description.

As illustrated in FIG. 2, the box making machine includes a sheet feeding section 1, a printing section 2, a slotter creaser section 3, a die-cut section 4, a folding section 5, and a counter-ejector section 6, which are disposed in turn from an upstream side in the sheet transfer direction TD. In FIG. 2, a process of processing a panel-shaped sheet 10 into a sheet for manufacturing a box 10A and a corrugated box 10B in a folded state is illustrated above the machine configuration, separately from the machine configuration. The sheet is transferred at a certain constant transfer speed over a linear transfer passage from the sheet feeding section 1 to the counter-ejector section 6.

A large number of sheets 10 are carried into the sheet feeding section 1 in a stacked state, and the sheets 10 are supplied to the printing section 2 one by one.

The printing section 2 includes printing units 2a to 2d having a predetermined number of colors (herein, four colors), and the printing section 2 performs printing, in turn, with respective colors of inks on the sheets 10 transferred one by one by a transfer conveyor 20.

In the slotter creaser section 3 and the die-cut section 4, groove cutting and creasing are performed on the sheet 10 on which printing is performed by the printing section 2. That is, in the slotter creaser section 3, groove cutting and creasing are performed on the sheet 10. In the die-cut section 4, a handhole and an air hole are drilled and punched in the sheet 10, thereby making the sheet for manufacturing a box 10A.

In the die-cut section 4, groove cutting and creasing for making a box with a special shape are also performed in some cases. Therefore, both of the slotter creaser section 3 and the die-cut section 4 have a function of performing groove cutting and creasing.

Then, in the folding section 5, glue is applied to a gluing margin at one end of the sheet for manufacturing a box 10A, on which groove cutting and creasing are performed, in the right-and-left direction, and folding is performed such that both end portions of the sheet for manufacturing a box 10A on the right and left overlap each other on the back side (lower side), thereby making the corrugated box 10B in a folded state, of which both end portions on the right and left are adhered to each other by glue. In the counter-ejector section 6, the corrugated boxes 10B in a folded state are counted and stacked, are sorted into a predetermined number of batches 100, and are discharged.

[Slotter Device]

Next, a slotter device 30 mounted on the slotter creaser section 3 will be described. The slotter device 30 is an apparatus that performs groove cutting with respect to the sheet 10.

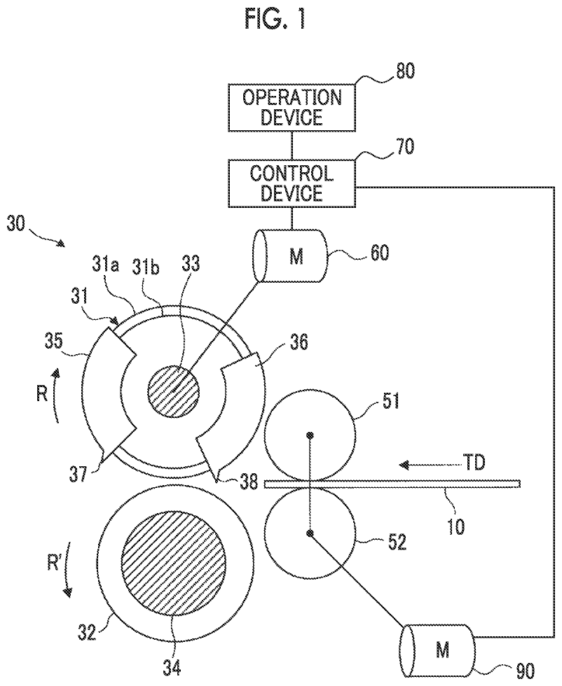

As illustrated in FIG. 1, transfer rollers 51 and 52 are provided upstream of the slotter device 30. The transfer rollers 51 and 52 transfer the sheet 10 creased by a creaser device (not illustrated) at a constant transfer speed along the transfer direction TD, and supply the sheet to the slotter device 30.

[Slotter Head]

The slotter device 30 has an upper slotter head 31 and a lower slotter head 32 which are disposed up and down to face each other with the transfer passage of the sheet 10 interposed therebetween.

The upper slotter head 31 is supported by an upper rotary shaft 33, and the upper rotary shaft 33 is connected to an upper motor 60. In addition, the lower slotter head 32 is supported by a lower rotary shaft 34, and the lower rotary shaft 34 is connected to a lower motor (not illustrated).

The upper motor 60 and the lower motor (not illustrated) are connected to a control device 70, and the control device 70 controls the rotational drive of the upper motor 60 and the lower motor. The upper motor 60 and the lower motor (not illustrated) rotationally drive the upper slotter head 31 and the lower slotter head 32 in rotation directions R and R′ which are the same direction as the sheet 10 transfer direction TD, respectively. The control device 70 is configured to include a CPU (not illustrated), a storage device including a ROM and a RAM, an input interface, an output interface, and a bus that connects the configuration elements to each other.

[Slotter Knife]

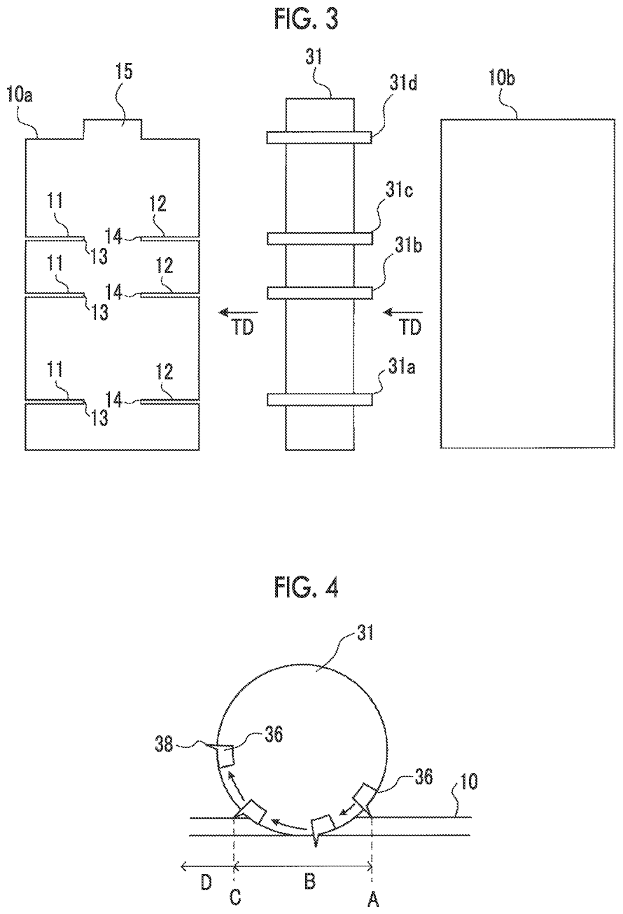

The two slotter knives 35 and 36 are attached to the upper slotter head 31 at an interval in a circumferential direction. One first slotter knife 35 is used in order to form a notch groove 11 (refer to FIG. 3) on a front side in the transfer direction TD, and the other second slotter knife 36 is used in order to form a notch groove 12 (refer to FIG. 3) on a rear side in the transfer direction TD. In addition, although details are not illustrated, the lower slotter head 32 includes a receiving knife formed of two knives attached to correspond to the slotter knives 35 and 36 at an interval.

[Protrusion Portion]

Protrusion portions 37 and 38 protruding from knife tips are provided at an end portion of the first slotter knife 35 on a rear side in the rotation direction R and an end portion of the second slotter knife 36 on a front side in the rotation direction R, respectively. By piercing the sheet 10, the protrusion portions 37 and 38 cut end portions 13 and 14 of the notch grooves 11 and 12 (refer to FIG. 3), respectively.

[Attachment Base of Slotter Knife]

In addition, in the present embodiment, the upper slotter head 31 includes a first base portion 31a that supports the first slotter knife 35 and a second base portion 31b that supports the second slotter knife 36, and is rotatable independently of each of the first slotter knife 35 and the second slotter knife 36. For this reason, although detailed illustration is omitted, the slotter device 30 includes, as the upper motor 60, a first motor for driving the first slotter knife 35 supported by the first base portion 31a and a second motor for driving the second slotter knife 36 supported by the second base portion 31b, and can rotationally drive the first slotter knife 35 and the second slotter knife 36 individually.

In addition, the first slotter knife 35 and the second slotter knife 36 are attached such that a mutual interval therebetween in the circumferential direction is adjustable. A mutual interval between a rear end portion of the first slotter knife 35 and a front end portion of the second slotter knife 36 is set depending on a box depth determined as specifications of a corrugated board to be processed.

FIG. 3 is a view of main parts of the slotter device 30 seen from above. As illustrated in FIG. 3, four upper slotter heads 31 are provided at predetermined intervals in an axial direction. In FIG. 3, the individual upper slotter heads are distinguished by the reference signs 31a, 31b, 31c, and 31d. In addition, although not illustrated in FIG. 3, four lower slotter heads 32 are provided to correspond to the four upper slotter heads 31.

In the sheet 10 transferred along the transfer direction TD, the slotter device 30 forms the notch grooves 11 and 12 at three positions on the sheet 10 with three upper slotter heads 31a, 31b, and 31c (and three lower slotter heads 32 corresponding thereto), and forms a gluing margin 15 of the sheet 10 with the upper slotter head 31d (and the lower slotter head 32 corresponding thereto). FIG. 3 illustrates a first sheet 10a after groove cutting is performed by the slotter device 30 and a second sheet 10b before groove cutting, which follows the first sheet 10a.

[Rotation Control]

The control device 70 controls the rotational drive of the upper motor 60 and the lower motor such that the slotter device 30 transfers the sheet 10 at a certain constant transfer speed while forming the notch grooves 11 and 12 at appropriate positions on the sheet 10 during the transfer. Specifically, the control device 70 controls the lower slotter head 32 such that the circumferential speed of the lower slotter head 32 becomes equal to the transfer speed of the sheet 10. On the other hand, with respect to the upper slotter head 31, the control device 70 controls the rotation speed of the motor 60 such that the rotation position of the upper slotter head 31 is an appropriate position with respect to the transfer position of the sheet 10, that is, such that each of the slotter knives 35 and 36 can appropriately process the sheet 10 at an appropriate position.

Herein, an outer circumferential surface of the upper slotter head 31 is in contact with an upper surface of the sheet 10. For this reason, the control device 70 basically controls the rotational drive of the upper slotter head 31 such that the circumferential speeds of the knife tips of the slotter knives 35 and 36 provided on an outer circumference of the upper slotter head 31 becomes equal to the transfer speed of the sheet 10.

Since the protrusion portions 37 and 38 respectively provided on the slotter knives 35 and 36 of the upper slotter head 31 protrude outward from the knife tips of the respective slotter knives 35 and 36, the circumferential speeds of tips of the protrusion portions 37 and 38 are higher than the circumferential speed of the outer circumference of the upper slotter head 31 (or the circumferential speed of an outer circumference of each of the slotter knives 35 and 36).

Due to this difference in the circumferential speed, simply controlling the circumferential speed of the outer circumference of the upper slotter head 31 to become equal to the transfer speed of the sheet 10 opens up a possibility that cracks (gouges) are generated in the end portion 14 of the notch groove 12 when forming the notch groove 12 with the second slotter knife 36, thereby causing a problem.

[Rotation Position of Protrusion Portion When Cutting]

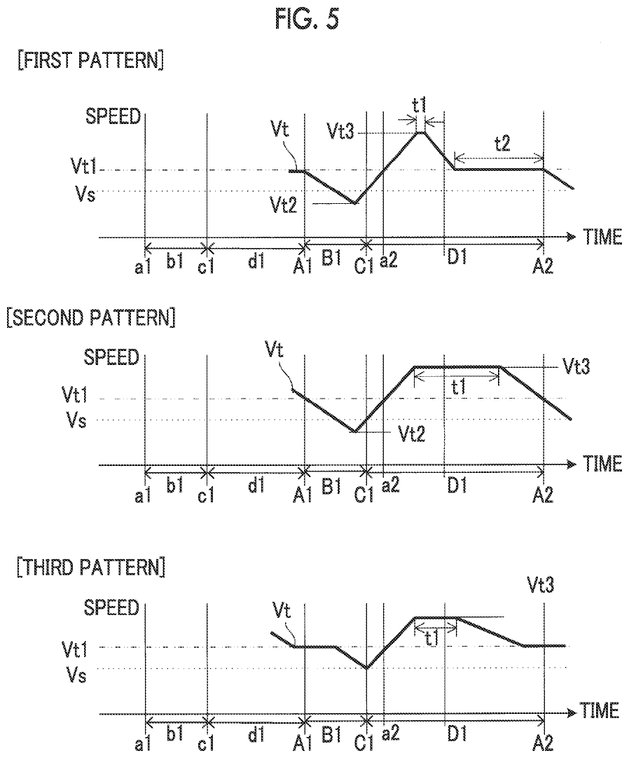

FIG. 4 is a schematic view illustrating a relationship between the sheet 10 and the second slotter knife 36 when cutting the notch groove 12. The problem will be described with reference to FIG. 4. A time point when the tip of the protrusion portion 38 of the second slotter knife pierces the sheet 10 and a phase state where cutting of the notch groove 12 starts has been reached will be referred to as “A”, a period during the cutting of the notch groove 12 by the second slotter knife 36 after the time point A will be referred to as “B”, a time point when the cutting of the notch groove 12 is finished and a phase state where the tip of the protrusion portion 38 comes out of the sheet has been reached will be referred to as “C”, and a period when a phase state where the tip of the protrusion portion 38 separates away from the sheet until piercing the following sheet, after the tip of the protrusion portion 38 has come out of the sheet (sheet non-cutting section) will be referred to as “D”.

A portion that the protrusion portion 38 has pierced at the time point A is the end portion 14 of the notch groove 12. When the circumferential speed of the second slotter knife 36 is equal to the transfer speed of the sheet 10, the circumferential speed of the protrusion portion 38 with respect to the sheet 10 is higher than the transfer speed of the sheet 10 even if the phase of the protrusion portion 38 and the phase of the end portion 14 of the notch groove 12 at the time point A match each other. Therefore, the phase of the protrusion portion 38 is ahead of the phase of the end portion 14 of the notch groove 12 until reaching the time point C through the period B. Herein, the “phase of the protrusion portion” corresponds to the rotation angle of the protrusion portion 38 (second slotter knife 36). In addition, the “phase of the end portion” is the position of the end portion 14 of the notch groove 12 in the transfer direction TD.

For this reason, after the protrusion portion 38 of the second slotter knife 36 pierces the sheet 10 (the time point A), the protrusion portion 38 pushes up the end portion 14 when the protrusion portion 38 comes out of the sheet 10 at the time point C, thereby causing problems such as cracks (gouges) in the end portion 14.

Regarding this point, in the present embodiment, as will be described below, as for the second slotter knife 36 forming the notch groove 12, the control device 70 controls a relative relationship between the circumferential speed of the slotter knife 36 and the transfer speed of the sheet 10 such that the protrusion portion 38 does not interfere with the end portion 14 of the notch groove 12 at least at the time point C when the protrusion portion 38 comes out of the upper surface of the sheet 10.

In the following, the control of the circumferential speed of the second slotter knife 36 will be described by focusing on the protrusion portion 38 of the second slotter knife 36 for the notch groove 12 related to the feature of the present embodiment.

The control by the control device 70 is mainly divided into (1) control of reducing the circumferential speed of the second slotter knife 36 such that the circumferential speed of the protrusion portion 38 becomes equal to or lower than the transfer speed of the sheet 10 at least at the time point C when the protrusion portion 38 comes out of the upper surface of the sheet 10 and (2) control of increasing, after the tip of the protrusion portion 38 has come out of the sheet, the circumferential speed of the second slotter knife 36 so as to be the same speed as the transfer speed of the sheet 10 in the sheet separation period D until the tip of the protrusion portion 38 pierces the following sheet.

[Timing Chart]

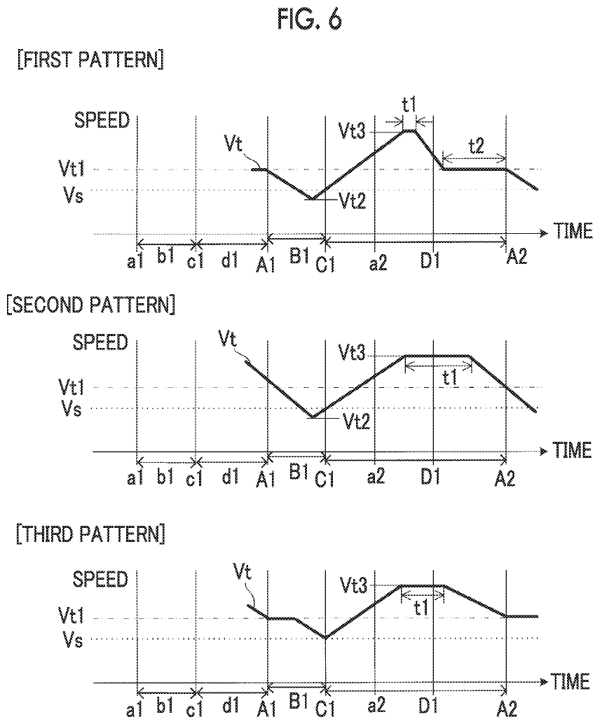

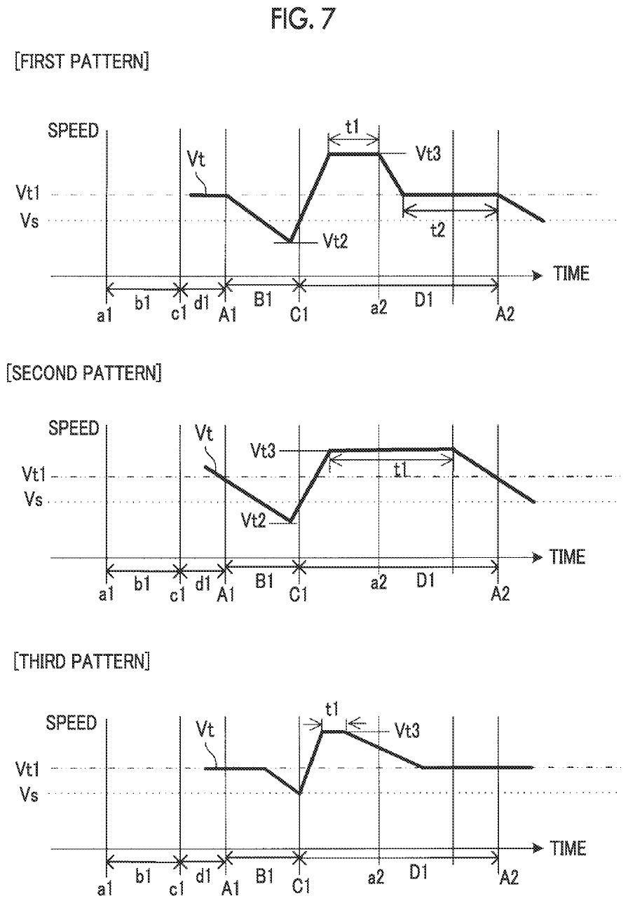

FIGS. 5 to 7 are timing charts showing speed increase and decrease control patterns of the circumferential speed of the slotter knife 36 according to the length of the sheet, in which the horizontal axis represents time and the vertical axis represents speed. Herein, the length of the sheet is the length of the sheet in the transfer direction. FIG. 5 shows a timing chart of a case where the sheet length is large. FIG. 6 shows a timing chart of a case where the sheet length is approximately medium. FIG. 7 shows a timing chart of a case where the sheet length is small. The size of the sheet length is relative and is not to specify a specific sheet length. However, when the sheet length is small, an interval between the transferred sheets is long and there is room for processing the following sheet, and when the sheet length is large, the interval between the transferred sheets is short and there is no room for processing the following sheet. This affects the speed increase and decrease control pattern of the circumferential speed of the slotter knife 36.

Hereinafter, description will be made with reference to FIGS. 5 to 7.

First, the flow of groove cutting will be briefly described.

At a time point a1, a front end portion of the first sheet 10a (refer to FIG. 3) enters a space between upper and lower slotter heads 31 and 32, and the cutting of the notch groove 11 starts. During a period b1, the cutting of the notch groove 11 proceeds. At a time point c1, the protrusion portion 37 pierces the first sheet 10a, and the cutting of the notch groove 11 ends.

In a period d1, an upper surface of the first sheet 10a is in contact with the rear end portion of the first slotter knife 35 and the front end portion of the second slotter knife 36. This period specifies the depth of the box (a distance between the notch groove 11 and the notch groove 12).

At a time point A1, the protrusion portion 38 pierces the upper surface of the first sheet 10a, and the cutting of the notch groove 12 starts. During a period B1, the cutting of the notch groove 12 proceeds. At a time point C1, the protrusion portion 38 comes out of the upper surface of the first sheet 10a, and the cutting of the notch groove 12 ends. A period D1 until the protrusion portion 38 pierces the second sheet 10b after the time point C1 is the sheet separation period.

After a time point a2, the same groove cutting is performed also in the following second sheet 10b (refer to FIG. 3).

In each of the timing charts shown in FIGS. 5 to 7, changes in a circumferential speed Vt of the protrusion portion 38 of the second slotter knife 36 from the time point A1 when the protrusion portion 38 pierces the first sheet 10a to a time point A2 when the cutting of the notch groove 12 of the following second sheet 10b starts are shown. In addition, a dotted line indicates a transfer speed Vs of the sheet 10, and a two-dot chain line indicates a circumferential speed Vt1 of the protrusion portion 38 in a case where the circumferential speed of the second slotter knife 36 is the same speed as the transfer speed Vs.

FIGS. 5 to 7 exemplify three types of speed increase and decrease control patterns having different speed decrease start timings from each other, that is, (1) a first pattern in which a speed decrease starts from the time point of the notch groove 12 cutting start, (2) a second pattern in which a speed decrease starts before the time point of the notch groove 12 cutting start, and (3) a third pattern in which a speed decrease starts during the cutting of the notch groove 12.

[First Pattern]

For example, in the case of the first pattern, the control device 70 starts the speed decrease control of the second slotter knife 36 from the time point A1. Accordingly, the circumferential speed Vt of the protrusion portion 38, which is the circumferential speed Vt1 at the time point A1, decreases, and decreases to a predetermined circumferential speed Vt2, which is equal to or lower than the transfer speed Vs, during the period B1 (before the time point C1). After then, the control device 70 starts increasing the circumferential speed of the second slotter knife 36 so that the circumferential speed Vt of the protrusion portion 38 becomes the same speed as the transfer speed Vs at the time point C1.

In this case, since the circumferential speed Vt of the protrusion portion 38 is equal to or lower than the transfer speed Vs (the same speed in the examples of FIGS. 5 to 7) at the time point C1, the phase of the protrusion portion 38 is the same as the phase of the end portion 14 of the notch groove 12 or is behind the phase of the end portion 14 of the notch groove 12. Therefore, when the tip of the protrusion portion 38 comes out of the first sheet 10a, the tip of the protrusion portion 38 can be prevented from interfering with the end portion 14 of the notch groove 12.

During the period D1 after the time point C1, the control device 70 starts increasing the circumferential speed of the second slotter knife 36 to the same speed as the transfer speed Vs. Specifically, the control device 70 increases the circumferential speed of the second slotter knife 36 to a speed higher than the transfer speed Vs, and then decreases the circumferential speed to the same speed as the transfer speed Vs. At this time, the control device 70 performs control of maintaining the circumferential speed of the second slotter knife 36 at a constant speed between a speed increase and a speed decrease. Accordingly, after increasing the circumferential speed Vt of the protrusion portion 38 to a predetermined circumferential speed Vt3, the circumferential speed Vt3 is maintained in a constant speed section t1. After then, the circumferential speed decreases to the circumferential speed Vt1. In a section t2 from the speed decrease to the time point A2, the control device 70 maintains the circumferential speed of the second slotter knife 36 at the same speed as the transfer speed Vs (maintains the circumferential speed of the protrusion portion 38 at the circumferential speed Vt1).

By performing speed increase and decrease control, the phase delay of the protrusion portion 38 caused by the speed decrease control up to the time point C1 can be returned to normal. In addition, by providing the section t1 in which a constant speed is maintained between a speed increase and a speed decrease, the rotation control of the second slotter knife 36 can be stably performed.

In the case of the first pattern, since the circumferential speed of the second slotter knife 36 need only be decreased to the same speed as the transfer speed Vs before the time point A2 when the tip of the protrusion portion 38 pierces the following second sheet 10b, the start timing and end timing of the speed decrease control may be set as appropriate by striking a balance between the section t1 and the section t2.

[Second Pattern]

In addition, in the case of the second pattern, the control device 70 starts speed decrease control of the circumferential speed of the second slotter knife 36 before the time point A1, decreases the circumferential speed of the protrusion portion 38 to the circumferential speed Vt2 during the period B1 (before the time point C1), and then controls and increases the circumferential speed of the second slotter knife 36 so that the circumferential speed Vt of the protrusion portion 38 becomes the same speed as the transfer speed Vs at the time point C1.

After increasing the circumferential speed of the second slotter knife 36 to a speed (speed at which the circumferential speed Vt of the protrusion portion 38 is Vt3) higher than the transfer speed Vs, the control device maintains the speed constant in the constant speed section t1, and then performs the speed decrease control of the circumferential speed of the second slotter knife 36 at an appropriate timing.

In the second pattern, the speed decrease control which starts before the cutting start (before the time points A1 and A2) is performed such that the circumferential speed Vt of the protrusion portion 38 becomes Vt1 at the time points A1 and A2, that is, the circumferential speed of the second slotter knife 36 becomes the transfer speed Vs. The timing when the speed decrease control starts need only be such that the circumferential speed Vt of the protrusion portion 38 becomes Vt1 at the time points A1 and A2, or may be set as appropriate by striking a balance with the length of the section t1.

[Third Pattern]

In addition, in the case of the third pattern, the control device 70 performs control such that the circumferential speed of the second slotter knife 36 is maintained at the same speed as the transfer speed Vs (the circumferential speed Vt of the protrusion portion 38 is maintained at Vt1) at the time point A1, and starts the speed decrease control of the circumferential speed of the second slotter knife 36 at an appropriate timing during the period B1 after the time point A1 such that the circumferential speed Vt of the protrusion portion 38 becomes the transfer speed Vs at the time point C1.

During the period D1 after the time point C1, the control device 70 increases the circumferential speed of the second slotter knife 36 to a speed (speed at which the circumferential speed Vt of the protrusion portion 38 is Vt3) higher than the transfer speed Vs, maintains the speed (the circumferential speed Vt3 of the protrusion portion 38) constant in the constant speed section t1, and then decreases the speed to the same speed as the transfer speed Vs. The speed decrease control during the period D1 need only decrease the circumferential speed of the second slotter knife 36 to the transfer speed Vs by the time point A2 when the cutting of the notch groove 12 of the following second sheet 10b starts. That is, the circumferential speed Vt of the protrusion portion 38 may decrease to Vt1 before the time point A2 as shown in FIG. 5, or may decrease to Vt1 at the time point A2 as shown in FIG. 6.

[Modification Example of Speed Increase and Decrease Control Pattern]

(1) The first patterns and the second patterns of FIGS. 5 to 7 may be patterns in which the circumferential speed Vt of the protrusion portion 38 decreases to the transfer speed Vs at the time point C1. The third patterns of FIGS. 5 to 7 may be patterns in which the circumferential speed Vt of the protrusion portion 38 decreases to Vt2, which is lower than the transfer speed Vs, before the time point C1 and then the circumferential speed Vt of the protrusion portion 38 increases to the transfer speed Vs at the time point C1.

(2) Since the circumferential speed Vt of the protrusion portion 38 need only be the transfer speed Vs at the time point C1 (moment when the protrusion portion 38 comes out of the sheet), all of the first to third patterns of FIGS. 5 to 7 may be patterns in which the circumferential speed Vt of the protrusion portion 38 decreases to the transfer speed Vs before the time point C1, the circumferential speed Vt is maintained at Vs for a certain period, and the speed starts increasing after the time point C1 has passed.

(3) All of the first to third patterns of FIGS. 5 to 7 may be patterns in which the circumferential speed Vt of the protrusion portion 38 decreases to the same speed as the transfer speed Vs at the time point C1 (moment when the protrusion portion 38 comes out of the sheet), further decreases also after the time point C1, and then increases.

[Selection of Speed Increase and Decrease Pattern According to Sheet Length]

An input device 80 is connected to the control device 70, and the length of the sheet to be processed can be input via the input device 80. The control device 70 stores the speed increase and decrease patterns according to a sheet length shown in FIGS. 5 to 7 in the storage device (not illustrated), selects an speed increase and decrease pattern corresponding to the input length of the sheet, and can control the circumferential speed of the second slotter knife 36 based on the selected speed increase and decrease pattern. Accordingly, circumferential speed control for the second slotter knife 36, in which a speed increase and decrease pattern optimal for the length of the sheet to be processed is used, is performed, and thus it is possible to more reliably prevent the protrusion portion 38 from interfering with the end portion 14 of the notch groove 12. A suitable speed increase and decrease pattern according to a sheet length is obtained in advance through experiments and is stored in the storage device (not illustrated).

As described above, in the present embodiment, the control device 70 prevents the protrusion portion 38 from interfering with the end portion 14 of the notch groove 12 when the protrusion portion 38 comes out of the upper surface of the first sheet 10a, with a simple configuration where a relative relationship between the circumferential speed of the second slotter knife 36 and the sheet transfer speed Vs is merely controlled such that the protrusion portion 38 does not interfere with the end portion 14 of the notch groove 12 at least at the time point C1 when the protrusion portion 38 comes out of the upper surface of the first sheet 10a. As a result, cracks (gouges) in the end portion 14 of the notch groove 12 can be prevented from being generated.

Control of making the protrusion portion 38 do not interfere with the end portion 14 of the notch groove 12 means relatively controlling the circumferential speed of the slotter knife and the sheet transfer speed Vs such that the phase of the protrusion portion 38 becomes equal to the phase of the end portion 14 of the notch groove 12 or is behind the phase of the end portion 14 of the notch groove 12 at least at the time point C1.

More specifically, the control device 70 performs control of making the circumferential speed Vt of the protrusion portion 38 equal to or lower than the sheet transfer speed Vs at least at the time point C1.

That is, the control device 70 can perform the control by decreasing the circumferential speed of the second slotter knife 36 such that the circumferential speed Vt of the protrusion portion 38 becomes equal to or lower than the sheet transfer speed Vs at least at the time point C1.

In addition, in the present embodiment, after the time point C1 when the tip of the protrusion portion 38 has come out of the first sheet 10a, it is preferable that the control device 70 increases the circumferential speed of the second slotter knife 36 to the same speed as the sheet transfer speed Vs in the sheet separation period D1 until the tip of the protrusion portion 38 pierces the following second sheet 10b.

More specifically, in the sheet separation period D1, it is preferable that the control device 70 performs control such that the circumferential speed of the slotter knife increases to a speed higher than the sheet transfer speed Vs and then decreases to be the same speed as the sheet transfer speed Vs.

The phase delay of the protrusion portion 38 can be eliminated through the speed increase and decrease control.

Further, it is preferable that the control device 70 performs control such that the circumferential speed of the second slotter knife 36 is maintained at a constant speed between a speed increase and a speed decrease in the sheet separation period D1.

By providing the constant speed section, the rotation control of the second slotter knife 36 can be stably performed.

In addition, it is preferable that the control device 70 controls the circumferential speed of the second slotter knife 36 based on a speed increase and decrease pattern according to the length of the sheet in the transfer direction TD.

Accordingly, the circumferential speed of the second slotter knife 36 can be controlled using a speed increase and decrease pattern optimal for the length of the sheet to be processed.

As a modification example of the present embodiment, the first slotter knife 35 and the second slotter knife 36 may be configured to be integrally and rotationally driven by one motor 60. In this case, speed increase and decrease control after the time point C1 is performed, before the first slotter knife 35 starts cutting the notch groove 11 of the following second sheet 10b at the time point a2, such that (1) the phase delay of the protrusion portion 38 is eliminated and (2) the circumferential speeds of the first slotter knife 35 and the second slotter knife 36 become the same speed as the transfer speed Vs.

In addition, although an example in which the control device 70 performs speed increase and decrease control for the circumferential speed of the second slotter knife 36 in the embodiment described above, the control device 70 may perform speed increase and decrease control of making the circumferential speed become the sheet transfer speed as a modification example. In this case, as illustrated in FIG. 1, the control device 70 is connected to a motor 90 that rotationally drives the transfer rollers 51 and 52, and controls the motor 90. The motor 90 rotationally drives the transfer rollers 51 and 52 such that the sheet transfer speed Vs becomes equal to or higher than the circumferential speed of the protrusion portion 38 at least when the protrusion portion 38, which has pierced the sheet 10, comes out of the sheet 10.

### REFERENCE SIGNS LIST

1 sheet feeding section

2 printing section

3 slotter creaser section

4 die-cut section

5 folding section

6 counter-ejector section

10 corrugated board (sheet)

11, 12 notch groove

13, 14 end portion

30 slotter device

31, 32 upper and lower slotter heads

35, 36 slotter knife

37, 38 protrusion portion

60 upper motor

70 control device

1. A slotter device comprising:
a slotter knife that is provided to rotate in the same direction as a transfer direction of a sheet being transferred through a transfer passage and includes, on an outer circumference thereof, a knife tip for forming a notch groove in the sheet;
a protrusion portion that is provided to protrude outward from the knife tip on one end portion of the slotter knife and cuts an end portion of the notch groove by piercing the sheet;
a drive device that rotationally drives the slotter knife; and
a control device that controls a relative relationship between a circumferential speed of the slotter knife and a transfer speed of the sheet such that the protrusion portion does not interfere with the end portion of the notch groove at least when the protrusion portion comes out of an upper surface of the sheet.

2. The slotter device according to claim 1,
wherein the control device relatively controls the circumferential speed of the slotter knife and the transfer speed of the sheet such that a phase of the protrusion portion becomes equal to a phase of the end portion of the notch groove or is behind the phase of the end portion of the notch groove, at least when the protrusion portion, which has pierced the sheet, comes out of the sheet.

3. The slotter device according to claim 1,
wherein the control device performs control of making the circumferential speed of the protrusion portion with respect to the sheet equal to or lower than the transfer speed of the sheet at least when the protrusion portion, which has pierced the sheet, comes out of the sheet.

4. The slotter device according to claim 1,
wherein the control device performs the control by decreasing the circumferential speed of the slotter knife such that the circumferential speed of the protrusion portion becomes equal to or lower than the transfer speed of the sheet at least when the protrusion portion, which has pierced the sheet, comes out of the sheet.

5. The slotter device according to claim 1,
wherein the control device increases the circumferential speed of the slotter knife to the same speed as the transfer speed of the sheet in a sheet separation period until a tip of the protrusion portion pierces a subsequent sheet following the sheet after the tip of the protrusion portion has come out of the sheet.

6. The slotter device according to claim 5,
wherein in the sheet separation period, the control device performs control such that the circumferential speed of the slotter knife increases to a speed higher than the transfer speed of the sheet and then decreases to be the same speed as the transfer speed of the sheet.

7. The slotter device according to claim 6,
wherein the control device performs control such that the circumferential speed of the slotter knife is maintained at a constant speed between the speed increase and the speed decrease in the sheet separation period.

8. The slotter device according to claim 1,
wherein the control device controls the circumferential speed of the slotter knife based on an speed increase and decrease pattern according to a length of the sheet in the transfer direction.

9. A box making machine comprising:
a sheet feeding section that supplies a sheet;
a printing section that performs printing on the sheet;
a slotter creaser section that performs creasing on the printed sheet and has the slotter device according to claim 1, which performs groove cutting;
a die-cut section that performs drilling and punching in the sheet, on which creasing and groove cutting are performed, to make into a sheet for manufacturing a box;
a folding section that applies glue to an end portion of the sheet for manufacturing a box and performs folding to form a box body; and
a counter-ejector section that discharges a predetermined number of the box bodies each time after counting and stacking the box bodies.
